(19) United States
(12) Patent Application Publication
(10) Pub. No.: US 2026/0152995 A1
(43) Pub. Date: Jun. 4, 2026

(54) WINDOW SECURITY SYSTEM

(71) Applicant: Neeseberry, LLC, Boston, MA (US)

(72) Inventor: Deigo Ricardo Stephane King, Wellesley, MA (US)

(73) Assignee: Neeseberry, LLC, Boston, MA (US)

(21) Appl. No.: 19/404,290

(22) Filed: Dec. 1, 2025

Related U.S. Application Data
(60) Provisional application No. 63/727,054, filed on Dec. 2, 2024.

(51) Int. Cl. E06B 9/01

(52) U.S. Cl. CPC E06B 9/01; E06B 2009/015

(57) ABSTRACT

A window security system can include a frame assembly including a plurality of segments. Each segment can have a first end and a second end and a central channel extending longitudinally between the first end and the second end. The central channel of at least one segment can receive a member for protecting a window. The window security system can include a connector hingedly coupling the frame assembly to a window frame of the window. The window security system can include a housing defined within a segment of the frame assembly. The housing can include a lock having an actuator coupled to a bolt. The lock can couple the frame assembly to the window frame in a locked position, where the actuator can drive the bolt into a recess defined in the window frame to position the member for protecting the window.

### CROSS-REFERENCE TO RELATED APPLICATIONS

This application claims benefit of and priority to U.S. Provisional Application No. 63/727,054, filed Dec. 2, 2024, the entirety of which is hereby incorporated by reference herein.

### BACKGROUND

Windows are common components in buildings, providing natural light, ventilation, and a view of the exterior. However, windows can be vulnerable to intrusion attempts or mechanical malfunctions. To enhance security and protection, window structures can incorporate security features.

### SUMMARY

At least one aspect of the present disclosure is directed to a window security system. The window security system can include a frame assembly including a plurality of segments. Each segment of the plurality of segments can have a first end and a second end and a central channel extending longitudinally between the first end and the second end. The central channel of at least one segment can be configured to receive a member for protecting a window. The window security system can include a connector hingedly coupling the frame assembly to a window frame of the window. The window security system can include a housing defined within a segment of the frame assembly. The housing can include a lock including an actuator coupled to a bolt. The lock can be configured to couple the frame assembly to the window frame in a locked position, where, in the locked position, the actuator can drive the bolt into a recess defined in the window frame to position the member for protecting the window.

The member can include at least one of a bar, a decorative panel, a solid panel, or a reinforcing plate. The central channel of the at least one segment can be configured to receive the member in a movable engagement. The housing can be defined within a first segment of the frame assembly. The first segment can be positioned opposite a second segment of the frame assembly. The second segment can be coupled to the window frame. The frame assembly can include a fourth segment coupled to a first segment and a second segment of the frame assembly, where the first and second segments can be parallel to each other. The frame assembly can include a third segment extending perpendicularly from the first end of a second segment of the frame assembly, where the second segment is coupled to the window frame. The third segment can include at least one hole positioned at a distance from an edge of the third segment, where the edge of the third segment can be coupled to a first segment of the frame assembly. The at least one hole in the third segment can align with a corresponding hole in the first segment to define a common axis for receiving the bolt.

The lock can be an electro-mechanical lock including the actuator coupled to the bolt. The bolt can be slidably engaged with a rail configured to guide movement of the bolt. In an unlocked position, the bolt can retract from the recess defined in the window frame. In the unlocked position, a segment of the frame assembly coupled to the window frame can be configured to pivot outward relative to the window frame. The window security system can include a sleeve configured to surround the bolt during extension and retraction within the window frame. The housing can further include a manual release configured to disengage the lock, the manual release comprising at least a key-operated control, a lever-operated control, or a spring-loaded plunger. The housing can further include an access panel for operating the manual release.

The housing can further include a transceiver configured for wireless communication with one or more external devices. The housing can further include a controller operatively coupled to the transceiver. The controller can be configured to activate the lock in response to receiving a control signal from the transceiver. The controller can be configured to deactivate the lock in response to receiving a deactivation signal from the transceiver. The housing can further include a sensor configured to detect a security event. The controller can be operatively coupled to the sensor. The controller can be configured to trigger an alert notification to a mobile application installed on one or more external devices in response to receiving a signal from the sensor indicating the security event. The security event can correspond to a deviation from a predetermined operating condition. The window security system can further include a power source to power the housing. The plurality of segments can be interconnected by mitered joints.

At least one aspect of the present disclosure is directed to a method of securing a window. The method can include providing a frame assembly having a plurality of segments. Each segment can have a first end and a second end and a central channel extending longitudinally between the first end and the second end. The method can include receiving, within the central channel of at least one segment, a member for protecting the window. The method can include hingedly coupling, using a connector, the frame assembly to a window frame of the window. The method can include defining, within a segment of the frame assembly, a housing including a lock including an actuator coupled to a bolt. The method can include driving, using the actuator, in a locked position, the bolt of the lock into a recess defined in the window frame for positioning the member for protecting the window.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. As used in the specification and in the claims, the singular forms of “a”, “an”, and “the” include plural referents unless the context clearly dictates otherwise.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 illustrates an isometric view of an example window security system, in accordance with some implementations.

FIG. 2 illustrates an exploded view of an example window security system, in accordance with some implementations.

FIG. 3 illustrates a front view of an example window security system, in accordance with some implementations.

FIG. 4 illustrates a locked position of an example window security system, according to an implementation,

FIG. 5 illustrates an unlocked position of an example window security system, according to an implementation.

FIG. 6 illustrates a sleeve of an example window security system, according to an implementation.

FIG. 7 illustrates an isometric view of an example window security system without bars, in accordance with some implementations.

FIG. 8 illustrates an example electronic locking system, in accordance with some implementations.

FIG. 9 illustrates another exploded view of an example window security system, in accordance with some implementations.

FIG. 10 illustrates another exploded view of an example window security system, in accordance with some implementations.

FIG. 11 illustrates another front view of an example window security system, in accordance with some implementations.

FIG. 12 illustrates another front view of an example window security system, in accordance with some implementations.

FIG. 13 depicts an example operational method of securing a window, in accordance with some implementations.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

A window frame is the structural enclosure that surrounds and supports the entire window system. The window frame can hold the glass panes in place and provide structural integrity to the wall opening through multiple bars. In this regard, window frames can be vulnerable to tampering or deformation during forceful break-ins. This vulnerability can arise when intruders use prying tools or blunt-force instruments to dislodge the bars or remove them with applied force. Additionally, insufficient coupling or improper alignment between the window and the window frame can result in structural weaknesses, leading to stress concentrations and compromising the integrity of the window. Such vulnerabilities can make windows and the corresponding window frames susceptible to forced removal or damage, thereby posing a significant security risk.

Furthermore, window frames can lack quick-release features, which can pose significant safety risks during emergencies such as fires, medical crises, or other urgent situations. The inability to quickly disengage the window frames can delay evacuation, hinder access for first responders, and lead to potential mechanical and operational challenges. Such challenges include delayed egress, where obstructed escape routes or the time-consuming manual removal of bars or locking components can result in tragic consequences under stress. Additionally, the absence of quick-release features can increase the likelihood of property damage, as individuals may resort to forceful removal methods that can damage the window frame, bars, or surrounding structures.

The systems and methods described herein can address the challenges of tampering, lack of rigidity, and emergency accessibility by providing a window security system that can provide enhanced protection, secure attachment, and adaptability. The window security system can include a frame assembly configured to receive members and attach to existing window frames for stability, where the members can include structural elements such as rigid bars or panel sections configured to protect the window. A housing within the frame assembly can integrate a locking mechanism to couple the frame assembly to the window frame, such that the members can be held in place to protect the window in a locked position. The window security system can be configured to be modular and retrofittable, providing compatibility with a variety of window frames and bars. For example, by incorporating a frame assembly with integrated channels for member or bar placement, the solutions can provide both structural integrity and flexibility.

Furthermore, the systems and methods described herein can include a lock system configured to provide enhanced security and emergency functionality. The lock system can be configured to detect security events, such as unauthorized access attempts, tampering, environmental conditions, or other events. Upon detecting a security event, the lock system can generate an alert notification, including details about the event, and transmit it to a user's device. This configuration can facilitate prompt communication and user awareness. Additionally, the lock system can include a power source configured to actuate the actuator, allowing the frame assembly to be disengaged from the window opening during emergencies. The solutions can provide functionality for the frame assembly to disengage rapidly for egress or access during emergencies, while maintaining structural stability and operational performance under normal conditions.

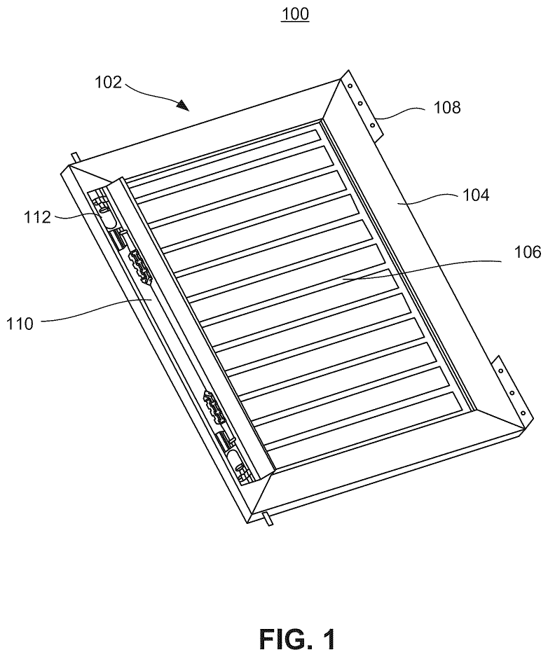

Referring now to FIG. 1, an isometric view of an example window security system 100 is shown, according to an implementation. The window security system 100 can include a frame assembly 102. The frame assembly 102 can be made of a variety of materials, including wood, metal (e.g., aluminum, steel, or titanium), plastic (e.g., polycarbonate, ABS, or PVC), or composite materials. The frame assembly 102 can include one or more segments 104. The segments 104 can be rectangular, tubular, or circular in cross-section. The segments 104 can be hollow, defining internal channels to accommodate additional components such as bolts, wiring, or bars. The segments 104 can be interconnected using mitered joints, butt joints, or tongue-and-groove connections. The segments 104 can be reinforced with ribbing or internal support structures.

The frame assembly 102 can receive one or more bars 106 for a window. The bars 106 can extend across the window opening. The bars 106 can be made of hardened steel, stainless steel, or titanium. The bars 106 can be coated with polymer materials. The bars 106 can be slidably received within channels of the segments 104. The bars 106 can be coupled to the segments 104 using fasteners, such as screws, rivets, or bolts.

The frame assembly 102 can include one or more connectors 108 to connect or attach the frame assembly 102 to a window frame of a window. The connectors 108 can be hinged, allowing the frame assembly 102 to swing open or closed. The connectors 108 can be made of corrosion-resistant metals or high-strength polymers and can include bushings or bearings. The connectors 108 can include quick-release mechanisms to facilitate easy installation and removal. The connectors 108 can include adjustable brackets to accommodate various window sizes and shapes.

The frame assembly 102 can include a housing 110 defined within one or more segments of the frame assembly 102. The housing can be a compartment or enclosure within the frame assembly 102 where various components can be housed. The housing 110 can be integrated into a segment 104 of the frame assembly 102. This segment 104, including the housing 110, can be positioned opposite the segment 104 coupled to the window frame. The housing 110 can enclose a lock assembly 112 (or also referred to herein as a lock 112). The lock 112 can be positioned in different configurations within the frame assembly 102, depending on the implementation. In one example, a single lock 112 can be integrated into a single segment 104 of the frame assembly 102. In another example, two separate locks 112 can be positioned within a single segment 104, providing multiple locking points along the same segment 104. The frame assembly 102 can include two locks 112, with one lock 112 integrated into each of two parallel segments 104 of the frame assembly 102. In yet another embodiment, the frame assembly 102 can include four locks 112, with two locks 112 positioned on each of the two parallel segments 104.

The lock 112 can be an electro-mechanical lock 112 or a mechanical lock 112. The electro-mechanical lock 112 can include an actuator (e.g., a solenoid or motor) coupled to a bolt that is slidably engaged with a rail. The bolt can extend into the window frame when in the locked position. The housing 110 can include a power source, such as a battery, hardwired power source, or solar panel mounted on the frame assembly 102, to power the components housed within the housing 110, including the actuator. The lock 112 can be controlled by a single process and power source integrated within the housing 110. The lock 112 can be controlled remotely using a software application or through communication protocols, such as Bluetooth connectivity, RFID authentication systems, biometric scanning devices, or voice recognition modules.

The lock 112 can include a manual override system, such as a key-operated cylinder or lever, allowing the lock 112 to be disengaged. The housing 110 can include a sensor system configured to detect security events, such as forced entry attempts, vibration, glass breakage, power supply issues, or unexpected mechanical resistance during locking or unlocking operations. For example, the housing 110 can include motion sensors, vibration sensors, or acoustic sensors.

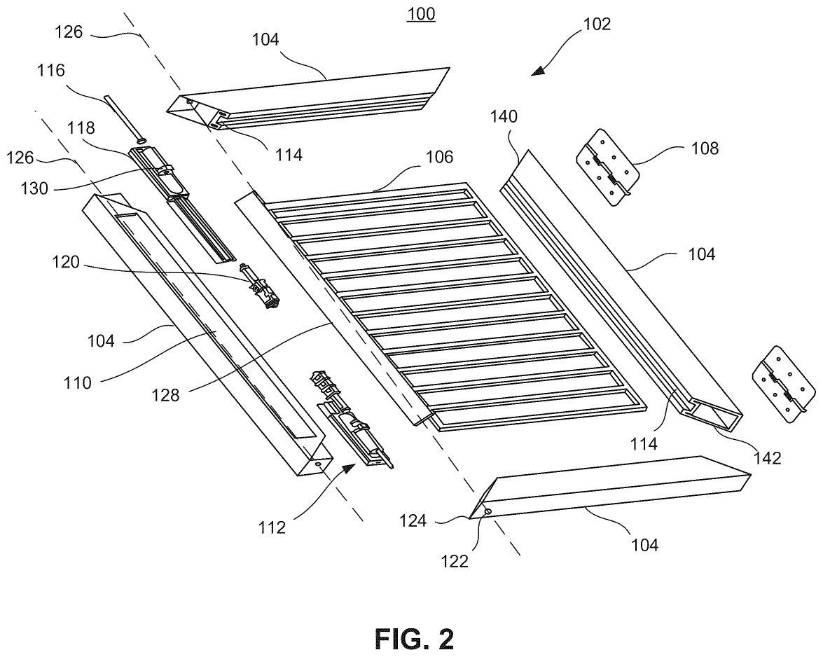

Referring now to FIG. 2, an exploded view of an example window security system 100 is shown, according to an implementation. The frame assembly 102 can include one or more segments 104 that can have a similar or varying shape and structure. Each segment 104 can have a hollow, elongated profile. The cross-section of each segment 104 can include a trapezoidal or polygonal shape. The external surfaces of the segments 104 can include angular edges to enhance the structural integrity. The internal portion of the segment 104 can include channels 114 or grooves to provide guideways for slidable bars 106 or as housings for additional components, such as locking mechanisms or wiring. The central channel 114 of a segment 104 can be configured to slidably receive the bars 106 to facilitate linear movement along the segment 104. The one or more segments 104 of the frame assembly 102 can be arranged parallel to one another. The one or more segments 104 can be oriented perpendicularly to one another, such that a segment 104 can extend perpendicularly from an end of another segment 104 to which it is coupled. The one or more segments 104 can be arranged such that a segment 104 can be coupled to two parallel segments 104 of the frame assembly 102.

The segments 104 can be interconnected using mitered joints, where the ends 140, 142 of each segment 104 can be angled (e.g., at 45, 60, or 90 degrees) to provide a seamless connection. The angles can vary depending on the desired frame shape or application, such as acute, obtuse, or right angles. Each segment 104 can be cut at a specific angle, such as 45 degrees. The angled ends 140, 142 can be matched to form the intended joint angle, such as two segments 104 cut at 45 degrees forming a 90-degree joint. The mitered joints can be secured using adhesives, fasteners (e.g., screws or bolts), or welding. The segments 104 can include integrated alignment features, such as pins and corresponding holes or tongue-and-groove structures. The channels 114 within the segments 104 can also function as interlocking features. For example, one segment 104 can have protrusions that fit into the channels 114 of adjacent segments 104. The channels 114 can provide a tight, interlocking fit that resists movement and separation.

Each segment 104 can be shaped to allow for the slidable insertion of the bars 106 through the channels 114. The channel 114 can extend along the length of the respective segment 104. The channel 114 can extend from a first end 140 to an opposite end 142 of the segment 104. The channels 114 can guide and hold the bars 106 while still permitting movement when desired. For example, the channels 114 can include a U-shaped or rectangular cross-section to accommodate the bars 106. The channels 114 can have reinforced edges or grooved interiors to reduce friction and allow for smooth sliding of the bars 106. The configuration can provide adjustments or removal of the bars 106 when the frame assembly 102 is in the unlocked state. The segments 104 can include notches or stops within the channels 114 to restrict the movement of the bars 106 at certain positions, such that the bars 106 remain securely in place when the frame assembly 102 is in the locked state.

The frame assembly 102 can include one or more connectors 108. The connector 108 can have a rectangular base with multiple circular holes distributed across its surface. The holes can be used as mounting points for fasteners, such as screws, bolts, or rivets, to couple the connector 108 to the adjacent segment 104 or the window frame. The connector 108 can include an integrated hinge mechanism, allowing rotational movement between the frame assembly 102 and the window frame. The connector 108 can allow the frame assembly 102 to swing open or closed. The connectors 108 can be positioned on opposite parallel segments 104 of the frame assembly 102 to connect the respective segments 104 to the window frame. The connectors 108 can include a sliding mechanism, such as rails or tracks, that allows the frame assembly 102 to slide along the window frame. The connectors 108 can include a quick-release mechanism, such as a lever or a latch, that allows the frame assembly 102 to be quickly detached from the window frame.

The frame assembly 102 can include one or more segments 104 having a hollow interior, referred to herein as a housing 110. The housing 110 can extend along the length of the segment 104 to provide a space for housing various components. The housing 110 can include one or more locks 112, which can be integrated into the interior to couple the frame assembly 102 to the window frame of the window. The lock 112 can include a bolt 116, a side rail 118, and an actuator 120 or related locking mechanism. The bolt 116 can be an elongated, cylindrical, or rectangular component configured to engage within a side rail 118. The bolt 116, in its extended position or locked state, can engage with a recess or receiving slot in the window frame to couple the frame assembly 102 to the window frame. In the locked position, the bars 106 can be positioned along the frame assembly 102 to shield or secure the window from intrusion or unauthorized access. In its retracted position or unlocked state, the bolt 116 can withdraw from the recess or receiving slot to disengage the frame assembly 102 from the window to allow movement or removal of the frame assembly 102. The side rail 118 can include grooves or channels to guide movement of the bolt 116. The slide rail 118 can be made of metal or a plastic material. The grooves in the side rail 118 can include low-friction coatings or inserts to reduce wear. The actuator 120 can control the movement of the bolt 116. The actuator 120 can include a motor or solenoid that applies linear or rotational force to drive the bolt 116 into or out of the locking position. The actuator 120 can further incorporate gearing systems or linkage mechanisms to amplify or direct the motion of the bolt 116. The actuator 120 can be powered by a local power source, such as batteries, wall outlets, power banks, or solar energy. The actuator 120 can be integrated into the central power system of the frame assembly 102.

The lock 112 can include a manual release 130 configured to disengage the lock 112. The manual release 130 can include at least a key-operated control or a lever-operated control. The manual release 130 can be implemented as a spring-loaded plunger, a rotational knob, or a push-button mechanism. When engaged, the manual release 130 can mechanically interact with the locking components to bypass electronic or automated controls, such that the lock 112 can be disengaged in scenarios such as power failure or system malfunction. The manual release 130 can be integrated into the housing 110 to address electro-mechanical failures. The manual release 130 can include a release pin that can be pushed to disengage actuators or locking components, allowing the frame assembly 102 to swing open.

A low-tech version of the window security system 100 can be designed for customers or users who do not use smartphones or other smart technologies. For this low-tech configuration, the housing 110 can replace the actuator with a fully mechanical bolting system. The manual system can be operated by opening a service panel 128 and manually moving the bolt 116 to the unlocked position. This version can be mounted with a hinge on one side and bolts 116 on the other side or, optionally, with bolts 116 on both sides for additional security.

The one or more segments 104 of the frame assembly 102 can be configured with holes 122 to allow the bolt 116 or a fastener to extend or retract through the hole 122. Each hole 122 can be positioned at a specific distance from the edges 124 of the segments 104. For example, the holes 122 can be positioned at a distance ranging from 5 mm to 20 mm from the nearest edge 124 of the segment 104. The diameter of each hole 122 can be based on the size of the bolt 116. For example, if the bolt 116 has a diameter of 10 mm, the hole 122 can have a diameter ranging from 10.5 mm to 12 mm to provide sufficient clearance for insertion and operation while preventing excessive movement or instability. The holes 122 in each segment 104 can align with corresponding holes 122 in adjacent segments 104. For example, the aligned holes 122 can define a common axis 126 that traverses the holes 122 of segments 104 perpendicularly coupled to one another. The common axis 126, extending through one or more holes 122 of the one or more segments 104, can be parallel to other common axes in the frame assembly 102. The common axis 126 can extend through the hole 122 of the segment 104 positioned across and parallel to the segment 104 through which the common axis 126 is initially traversing.

One or more segments 104 of the frame assembly 102 that include holes 122 can also have additional connection points, such as mounting holes for brackets used to install window blinds. These brackets can mount window blinds directly onto the frame assembly 102, if desired, and provide versatility for different window configurations. The frame assembly 102 can include a control box integrated with or mounted on one of the segments 104. The control box can perform remote operations, allowing users to open or close the window bar assembly remotely.

The frame assembly 102 can include a service panel 128 configured to cover the housing 110, which includes the lock 112. The service panel 128 can be implemented in various embodiments to facilitate access and manipulation of the lock 112. For example, the service panel 128 can be flush mounted in the frame assembly 102. The service panel 128 can be hingedly coupled to the frame assembly 102. The service panel 128 can include a sliding mechanism using tracks or guide rails for horizontal or vertical movement. The service panel 128 can also be detachable, secured by fasteners, clips, or magnets to the frame assembly 102. The service panel 128 can include transparent sections or cutouts, allowing visual inspection or manipulation of the lock 112 without removing the service panel 128. During a mechanical override, the service panel 128 can provide access to the internal components of the housing 110. The service panel 128 can include an LED light that illuminates upon opening to enhance visibility.

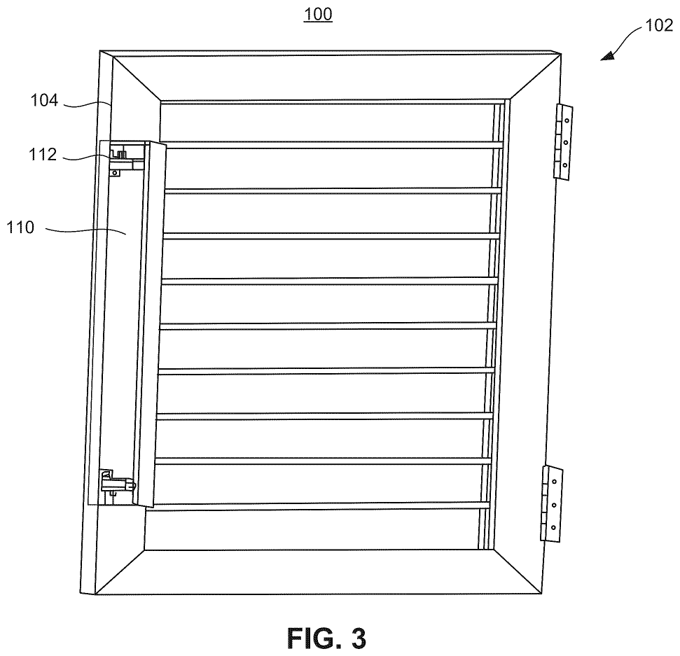

Referring now to FIG. 3, a front view of an example window security system 100 is shown, according to an implementation. The segment 104 is shown as including the housing 110 positioned vertically along the interior face of the segment 104. The housing 110 can be a continuous hollow structure that extends along the full length of the segment 104. The housing 110 can include two separate hollow structures, positioned at the top and bottom of the segment 104. The housing can be configured to hold the lock 112. The lock 112 can be mounted within the housing 110 to interact with other components of the frame assembly 102. The housing 110 can be used to protect the lock 112 from external tampering or environmental conditions, while allowing access for manual or automated operation of the locking mechanism.

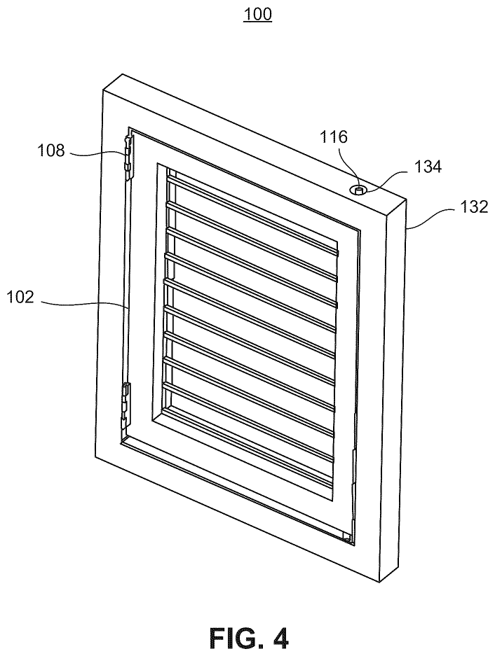

Referring now to FIG. 4, a locked position of an example window security system 100 is shown, according to an implementation. The frame assembly 102 can be coupled to a window frame 132 of a window using one or more connectors 108 positioned along one side of the frame assembly 102. The frame assembly 102 can be hingedly coupled to the window frame 132. The hinged coupling can facilitate rotational movement for opening or closing the frame assembly 102. The window frame 132 can define the boundary within which the frame assembly 102 is installed. The connector 108 can provide a rigid and secure attachment of the frame assembly 102 to the window frame 132.

In cases where space within the window frame 132 is limited, a support bracket can be used as an anchorage point to hold the frame assembly 102 in place. The support bracket can function as an extension of the window frame 132 and can include predefined holes or recesses to allow the locking mechanism (or the lock 112) of the frame assembly 102 to function as it would inside the window frame 132. For example, the bolt 116 can engage with recesses in the support bracket, thereby securing the frame assembly 102 to the bracket rather than directly into the window frame 132. The support bracket can provide additional stability and flexibility for installations where the window frame 132 cannot directly accommodate the locking mechanism (or the lock 112).

The window frame 132, or the support bracket when utilized, can include predefined recess 134 or slots configured to receive the bolt 116. The bolt 116 is shown in its extended position. For example, the bolt 116 is inserted into the recess 134 of the window frame 132 (or the support bracket), thereby securing the frame assembly 102 in place. The alignment of the bolt 116 with the recess 134 can prevent the movement of the frame assembly 102 relative to the window frame 132. The recess 134 can be sized and positioned to accommodate the bolt 116. The bolt 116, when engaged within the recess 134, can lock the frame assembly 102 in position.

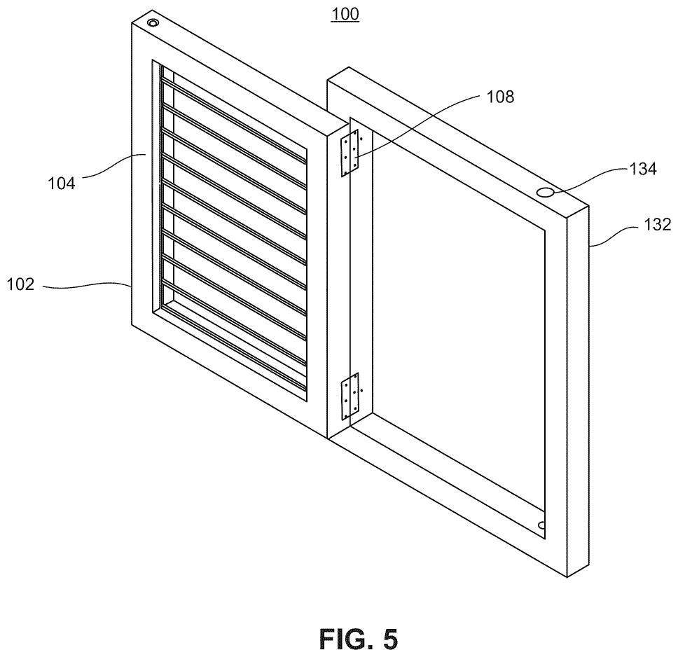

Referring now to FIG. 5, an unlocked position of an example window security system 100 is shown, according to an implementation. In the unlocked position, the bolt 116 can retract from the recess 134 defined in the window frame 132. This configuration can disengage the coupling between the segment 104 of the frame assembly 104 and the window frame 132 and can allow the frame assembly 104 to swing outward on its pivot hinges. The hinge or pivot can function as the axis around which the segment 104 of the frame assembly 102, coupled to the window frame 132 via the connector 108, pivots outward relative to the window frame 132. The retraction of the bolt 116 can be guided by slide rails 118 integrated within the housing 110. The retraction of the bolt 116 can be facilitated by a spring-loaded mechanism or an actuator 120. For example, the actuator 120 can apply the force to withdraw the bolt 116 from the recess 134. The slide rail 118 can include bolt restrictions or stops to limit the retraction of the bolt 116.

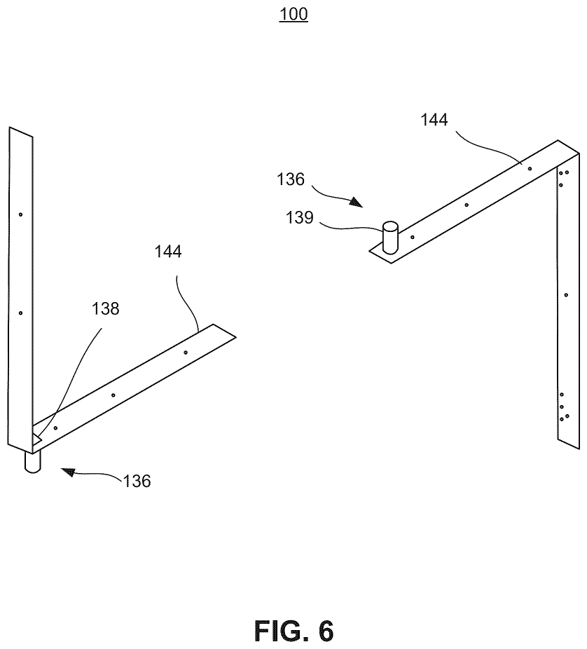

Referring now to FIG. 6, a sleeve of an example window security system 100 is shown, according to an implementation. The frame assembly 102 can include one or more sleeves 136 to provide sacrificial corrosion protection for internal components of the frame assembly 102, such as bolts or other structural elements. The sleeve 136 can be made of a magnesium alloy or other corrosion-resistant materials. The sleeve 136 can include an internal side and an external side. The sleeve 136 can include an aperture 138 on the internal side. The aperture 138 can be configured to be directly mounted onto the segment 104 to enclose and protect the bolt 116. For example, when the bolt 116 extends or retracts, the aperture 138 can shield the bolt 116 from environmental exposure, such as moisture, debris, or corrosive elements. The external side of the sleeve 136 can include a protrusion 139. The protrusion 139 can be sized to fit into the recess 134 of the window frame 132. The protrusion 139 can facilitate alignment between the sleeve 136 and the recess 134. The protrusion 139 can distribute mechanical stresses evenly, shielding the bolt 116 from external forces, such as impacts or tampering, and maintaining the structural integrity of the lock 112. As shown, the sleeve 136 can be attached to a metal plate 144, which can be L-shaped or any other suitable shape, such as a flat or angled configuration. The metal plate 144 can be affixed to one or more segments 104 of the frame assembly 102. The metal plate 144 can provide structural reinforcement to the frame assembly 102 and function as a stable mounting surface for the sleeve 136. The sleeve 136 can be positioned at the end of the metal plate 144 to align with the position of the bolt 116 and the corresponding recess 134 in the window frame 132.

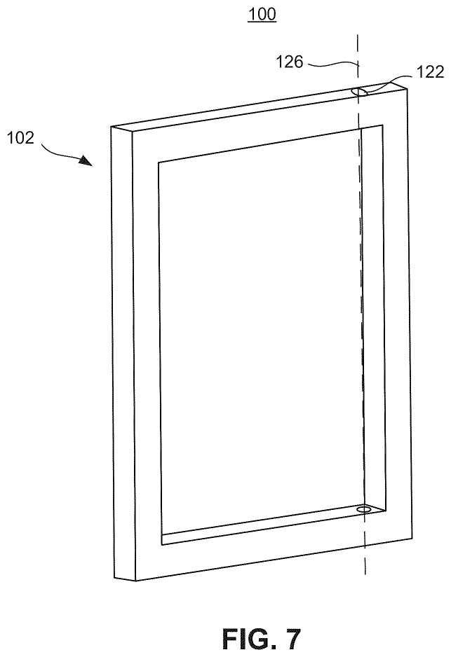

Referring now to FIG. 7, an isometric view of an example window security system 100 without bars is shown, according to an implementation. The frame assembly 102 can be configured to retrofit bars 106 of any size, shape, or material, providing flexibility in adapting the window security system 100 to specific security or design configurations. For example, the segments 104 of the frame assembly 102 can include internal channels 114 or grooves to facilitate the insertion and securement of bars 106. The common axis 126, as shown, traverses the holes 122 positioned on opposite sides of the frame assembly 102 along respective segments 104 incorporating the holes 122. The holes 122 can be aligned such that the common axis 126 passes directly through their centers to provide precise alignment between the segments 104. The opposing placement of the holes 122 can allow the common axis 126 to function as a reference line for structural stability, facilitating the secure installation and alignment of components such as bolts, locking mechanisms, or other hardware within the window security system 100.

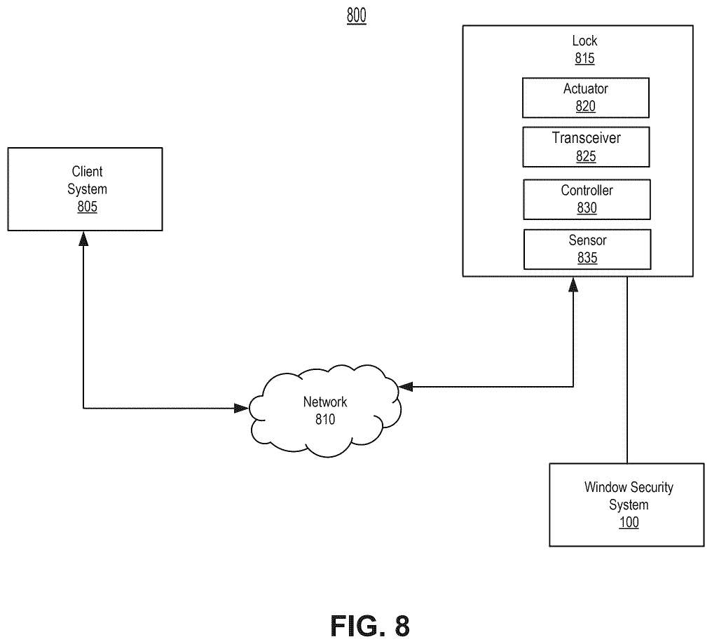

Referring now to FIG. 8, an example electronic lock system 800 is shown, according to an implementation. The electronic lock system 800 of FIG. 8 can include one or more systems, components, or functionalities depicted in FIGS. 1-7 and 9-12. The electronic lock system 800 can include one or more client systems 805 and one or more locks 815. One or more components of the electronic lock system 800 can communicate via network 810.

The client system 805 (also referred to herein as an external device 805) can include a computing system that can be used to control or access the functionality of the lock 815. The client system 805 can include a smart phone, mobile device, laptop computer, desktop computer, one or more servers, or any other type of computing device. The client system 805 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 805 can include one or more devices to receive input from a user or to provide output to a user. For example, the output capabilities of the client system 805 can be presented through a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto.

The client system 805 can execute an application that communicates with the lock 815. The client application can include a set of rules or protocols that allow different software programs or systems to communicate with each other. The client application can provide user interfaces to facilitate interaction. Users can view information or initiate actions through the client application. The client application can include a web application, a server application, a resource, a desktop, or a file. The client application can include a local application (e.g., local to a client system 805), a hosted application, a software-as-a-service (SaaS) application, a virtual application, a mobile application, and other forms of content. The client application can include or correspond to applications provided by remote servers or third-party servers.

The network 810 can include any type or form of network. The geographical scope of the network 810 can vary widely and the network 810 can include a body area network (BAN), a personal area network (PAN), a local-area network (LAN), e.g., Intranet, a metropolitan area network (MAN), a wide area network (WAN), or the Internet. The topology of the network 810 can be of any form and can include, e.g., any of the following: point-to-point, bus, star, ring, mesh, or tree. The network 810 can include an overlay network which is virtual and sits on top of one or more layers of other networks 810. The network 810 can be of any such network topology as known to those ordinarily skilled in the art capable of supporting the operations described herein. For example, the network 810 can be any form of computer network that can relay information between the client system 805 and the lock 815 of the electronic lock system 800 or the window security system 100. The network 810 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include application layer, transport layer, Internet layer (including, e.g., IPv6), or the link layer. The network 810 can include a type of a broadcast network, a telecommunications network, a data communication network, or a computer network.

The lock 815 can correspond to a locking mechanism configured to control access to windows, doors, gates, or other objects. The lock 815, as shown in FIG. 8, can be similar to the lock 112 shown in FIG. 1. The lock 815 can utilize electronic components to control the operation of the window locking mechanism remotely or locally. The lock 815 can receive commands and transmit status updates via the network 810. The lock 815 can be controlled remotely via the client system 805 or other connected devices. The lock 815 may incorporate a combination of mechanical, electromechanical, or electronic components.

The lock 815 can include one or more actuators 820, one or more transceivers 825, one or more controllers 830, or one or more sensors 835. The actuator 820, as shown in FIG. 8, can be similar to the actuators 120 shown in FIG. 1. The actuator 820 can be used for driving or physically actuating the locking mechanism, such as extending or retracting the bolt 116. The actuator 820 can be implemented as an electromechanical device that converts electrical signals into mechanical motion. The actuator 820 can include a motor (e.g., DC motor, stepper motor) or a solenoid, where the motor or solenoid provides linear or rotational movement to engage or disengage the bolt 116. The actuator 820 can be implemented as pneumatic or hydraulic actuators that use compressed air or fluid to generate force for heavy-duty objects. The actuator 820 can include limit switches or position sensors to detect the bolt's position to prevent overextension or retraction. The actuator 820 can be associated with a damping mechanism to minimize noise and vibrations during operation. The actuator 820 can be powered by a power source. The actuator 820 can be controlled by signals from the controller 830. The actuator 820 can be coupled to sliding rails 118 or gear assemblies to facilitate controlled motion of the bolt 116 or other securing components. Each sliding rail 118 can be configured to guide movement of the bolt 116 during extension and retraction.

The transceiver 825 in the lock 815 can be a device that combines a transmitter and a receiver in a single unit. For example, the transceiver 825 can transmit and receive signals. The transceiver 825 can include a processor and memory to perform signal processing and communication functions. The transceiver 825 can facilitate the exchange of data between the lock 815 and the client systems 805 or other external devices 805. The transceiver 825 can transmit and receive electronic signals over a communication network, such as network 810, to facilitate remote control, monitoring, or configuration of the lock 815. The transceiver 825 can operate over various mediums, such as radio waves, optical fibers, or electrical cables, depending on the implementation. The transceivers can decode and process the information included within the incoming signals. The transceivers encode and transmit signals to the network 810 to provide information to the client system 805 regarding the lock's status, such as its lock state, battery level, error codes, or security events.

The controller 830 in the lock 815 can be a device or software that manages, directs, or coordinates the operations of the electronic lock system 800. The controller 830 can include one or more processors and associated circuitry that execute instructions to perform control functions. The instructions can be stored in integrated memory within the controller 830 or in external memory accessible to the controller 830. The controller 830 can be configured to activate the lock 815 in response to receiving a control signal from the transceiver 825. The controller 830 can be operatively or functionally coupled to the transceiver 825 via a communication interface, such that the transceiver 825 can transmit data to the controller 830. The controller 830 can be configured to process the control signal transmitted by the transceiver 825, where the control signal can include one or more data packets including command instructions to activate or deactivate the lock 815. The transceiver 825 can relay electronic signals received from client systems 805 or other external devices 805 over a communication network, such as network 810, and the controller 830 can process these signals to determine the appropriate action. For example, upon receiving an unlocking signal, the controller 830 can cause the actuator 820 to retract the bolt 116, or upon receiving a locking signal, the controller 830 can cause the actuator 820 to extend the bolt 116 into the recess 134 or the corresponding receiving cavity of the window frame 132.

The controller 830 can track and manage the lock's operational states, including locked, unlocked, error states, or security events. A security event can correspond to a deviation from a predetermined operating condition, such as unauthorized access attempts, physical tampering, sensor failures, power supply issues, or unexpected mechanical resistance during locking or unlocking operations. The security events can also include triggers that prompt users to confirm the cause of the release of the frame assembly 102, such as fire, theft, flooding, or an unknown reason, aiding first responders in their response efforts. The controller 830 can trigger an alert notification to an application, including a mobile application, installed on one or more external devices, client devices, or systems in response to receiving a signal indicating a security event. The alert notification can be used to notify users when the electronic lock system 800 has been triggered. Alerts can also be sent to user devices such as cell phones via push notifications, text messages, emails, or app-based pop-up alerts. The electronic lock system 800 can transmit status notifications, such as malfunction alerts or low battery warnings, to keep users informed about the system's health and performance. Additionally, the electronic lock system 800 can implement two-factor authentication to enhance security and prevent unauthorized access.

The controller 830 can be operatively coupled to a sensor 835, which includes one or more detection devices, such as motion sensors, temperature sensors, or shock sensors, integrated within the lock 815 or the frame assembly 102. The controller 830 can receive data from the sensor 835 and use that data to execute specific actions or functions. The sensor 835 can be configured to detect security events via motion sensors, temperature sensors, or shock sensors. When the sensor 835 detects a potential security event, the sensor 835 can transmit a signal to the controller 830. Upon receiving the signal indicating the potential security event, the controller 830 can generate an alert message and transmit the alert message to the transceiver 825, which then relays the alert message over the network 810 to the client system 805. The controller 830 can log the event, temporarily disable the lock 112 to enhance security during the detected event, or actuate the actuator 820 to unlock the frame assembly 102 in response to predefined conditions, such as an emergency or system override. The controller 830 can be configured to deactivate the lock 815 in response to receiving a deactivation signal from the transceiver 825. The deactivation signal can include instructions to place the lock in a non-operational state, thereby preventing normal locking or unlocking operations during specific security events or in response to commands from the client system 805.

The controller 830 can validate control signals and facilitate secure communication before executing commands. The controller 830 can incorporate encryption protocols to authenticate the incoming signals. The controller 830 can monitor and manage the power system of the lock 815. For example, the controller 830 can deactivate one or more of the components during idle states to conserve battery life. The controller 830 can continuously monitor the status of the lock 815 and its components, such as the position of the bolt, battery levels, or tamper alerts, and transmit the information to the client system 805 via the transceiver 825. The controller 830 can execute predefined rules or customized routines for various functionalities, such as timed locking or unlocking schedules, integration with other smart home devices, or multi-user access management. The controller 830 can adapt to different application requirements to provide compatibility and scalability in a wide range of locking systems.

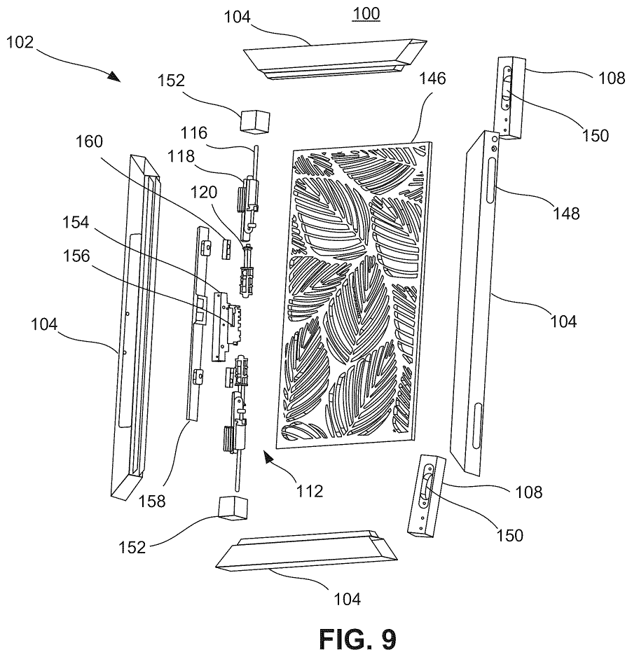

Referring now to FIG. 9, another exploded view of an example window security system 100 is shown, according to an implementation. As illustrated by way of example in FIG. 9, the frame assembly 102 can include multiple functional components. The frame assembly 102 can include a member 146. The member 146 can be positioned at the center of the frame assembly 102. The member 146 can be removably secured within grooves formed around the perimeter of the surrounding segments 104. The member 146 can be aligned or seated within the central channel 114 of one or more segments 104. The central channel 114 of the at least one segment 104 can be configured to receive the member 146 in a movable engagement. For example, the central channel 114 can be dimensioned and shaped to allow the member 146 to be inserted, removed, or repositioned within the frame assembly 102. The member 146 can include at least one of a bar, a decorative panel, a solid (transparent or opaque) panel, or a reinforcing plate. The member 146 can be held securely within the frame assembly 102. The member 146 can be fastened mechanically, for example, using screws. A user can replace the member 146 for aesthetic changes. The member 146 can provide storm protection or improved energy efficiency through added insulation.

One or more segments 104 can include a hinge location 148 to support pivotal mounting of the frame assembly 102 to the window frame 132. The frame assembly 102 can include an upper corner connector 108 (or the connector 108) and a lower corner connector 108 (or the connector 108) positioned on one of the segments 104 (e.g., the second segment 104). The corner connector 108, or the connector 108, can hingedly couple the frame assembly 102 to the window frame 132 of the window to support movement during opening and closing. Each corner connector 108 can have a hinge slot 150 configured to receive hinge hardware. The corner connectors 108, via the hinge slots 150, can support the frame assembly 102 during hinged opening and closing relative to the window frame 132. The corner connectors 108 can also be configured to interconnect adjoining segments 104 and can provide structural reinforcement to maintain angular alignment between the segments 104 of the frame assembly 102.

Within the housing 110 of the frame assembly 102, the lock 112 can be positioned to actuate bolts 116 (also referred to herein as locking pins 116). The locking pin 116 can be or refer to an elongate bolt, rod, or pin-shaped member configured to move between an engaged position and a retracted position. The locking pin 116 can be configured to enter a corresponding recess, opening, or retaining surface to inhibit or stop movement of the associated segment 104 relative to the window frame 132. The bolt 116 can function as the locking pin 116 when a corresponding distal end of the bolt 116 is configured to extend into the recess 134 of the window frame 132 to secure the frame assembly 102 and prevent displacement of the frame assembly 102. The locking pin 116 can be held in the engaged position by a retention element, including a compression spring, an extension spring, a torsion spring, a spring plate, or an elastomeric biasing member. The frame assembly 102 can include upper and lower connection blocks 152 positioned on respective portions of the segment 104 (e.g., the first segment 104), which includes the lock 112. The upper and lower connection blocks 152 can provide support for the locking pins 116 and can be arranged within the housing 110 at corresponding upper and lower positions to retain and guide the bolts 116. The bolts 116 or locking pins 116 can be operable in both manual and electronic configurations.

The frame assembly 102 can include a support 154 for mounting the actuator 120 of the lock 112 and for securing a printed circuit board (PCB) 156 within the housing 110 of the segment 104 of the frame assembly 102. The support 154 can be positioned adjacent to the PCB 156. The PCB 156 can provide control electronics for operating the lock 112, or the lock 815 as described in connection with FIG. 8. For example, the PCB 156 can include or host one or more transceivers 825, controllers 830, or sensors 835, as described in connection with FIG. 8.

The frame assembly 102 can further include an access panel 158, which can be interchangeable with the service panel 128. The access panel 158 or the access cover can be configured to cover the housing 110 defined within the first segment 104 of the frame assembly 102. The access panel 158 can incorporate locking, unlocking, and mounting features. The access panel 158 can include a hinge support 160 configured to facilitate opening of the access panel 158 and can provide access for operating the manual release 130.

The lock 112 (also referred to herein as a lock system 112) can be configured to operate in both manual and electronic modes. In manual operation, the lock 112 within the housing 110 can be accessed via the access panel 158. The access panel 158 can be opened by applying pressure, such as finger pressure, to a spring-loaded plunger. Activation of the spring-loaded plunger can cause the access panel 158 to partially open, for example. The one or more magnetic catches can retain the access panel 158 in a closed position until the spring-loaded plunger is actuated.

Once the access panel 158 is open, a user can manually push the locking pin 116 into a locked position for both the upper and lower portions of the segment 104 (e.g., the first segment 104), which includes the one or more locks 112. In the locked position, each locking pin 116 can be fully seated within a corresponding recess 134 defined in the window frame 132, where engagement between the locking pin 116 and the recess 134 can prevent withdrawal of the frame assembly 102 and maintain the locked position. The locking engagement can be implemented through frictional seating, interference between mating surfaces, a detent feature within the recess, a tapered recess geometry that can resist outward movement, or a hardened retaining surface configured to block displacement of the locking pin 116.

The forward end of the locking pin 116 can be aligned with the hole 122 or an opening in the corresponding segment 104. For example, the locking pin 116 can engage the hole 122 in the first segment 104 and the third segment 104 (or the fourth segment 104) when a single locking pin 116 is used, or the hole 122 in the first, third, and fourth segments 104 when two locking pins 116 are used, with the first segment 104 positioned between the third and fourth segments 104. The forward end of the locking pin 116 can then be inserted into the recess 134. The insertion can create a mechanical engagement that can block pivoting and shifting of the frame assembly 102 relative to the window frame 132. In the locked position, the actuator can drive the bolt 116 into the recess 134 defined in the window frame 132 to position the member 146 for protecting the window. The locked position can result in the frame assembly 102 being rigidly coupled to the window frame 132. Such an engagement can distribute the load evenly, resist prying or impact forces, and maintain alignment of the member 146 for protecting the window.

To unlock the frame assembly 102, a release pin or the manual release 130 associated with the lock 112 at the upper and lower portions of the segments 104 that house the lock 112 can be actuated or pushed to retract the locking pins 116 clear of the recesses 134 in cases where two locking pins 116 are used. Retraction of each locking pin 116 can remove the engagement that holds the frame assembly 102 in the locked position. The retracted position can create a clearance gap between each locking pin 116 and the recess 134, allowing free movement of the frame assembly 102 relative to the window frame 132. The manual release 130 can be configured to move both the upper and lower locking pins 116 simultaneously. A simultaneous movement mechanism can include linked rods, a cam arrangement, or a synchronized release lever configured to transmit motion from a single actuation point. A simultaneous release can unlock both the top and bottom locks 112 at the same time and can reduce the effort required to disengage the locking pins 116 individually. Once the locking pins 116 are disengaged, the frame assembly 102 can be free to pivot on the hinge side. The hinge-side engagement can include the corner connectors 108 with hinge slots 150 and can support a rotational motion of the frame assembly 102 to pivot outward away from the window frame 132.

In electronic mode or version, the lock 112 (or the lock 815) can be controlled by a remote control, a push button, or a mobile device. Electronic control signals can activate the actuator 120 (or the actuator 820) to extend the locking pins 116 into the recesses 134 or can deactivate the actuator 120 to retract the locking pins 116 for unlocking. The electronic mode can allow operation of the lock 112 from a distance and can support scheduled locking, manual override, or integration with security or home-automation systems.

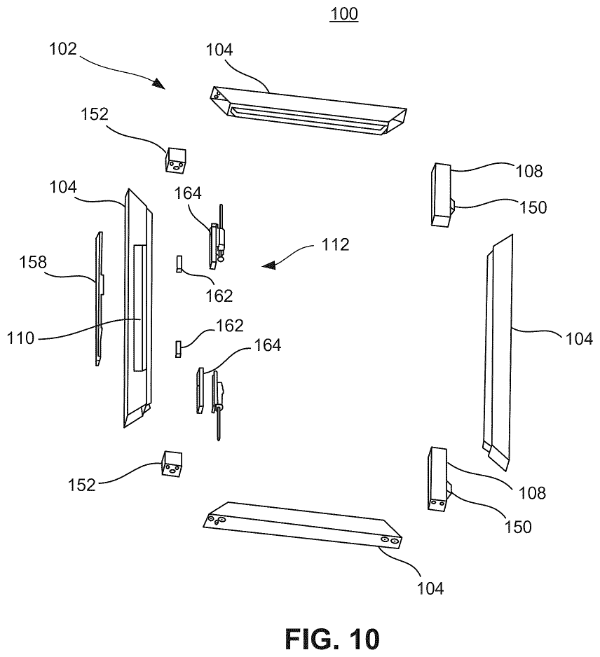

Referring now to FIG. 10, another exploded view of an example window security system 100 is shown, according to an implementation. As illustrated by way of example in FIG. 10, the frame assembly 102 can have a configuration similar to the configuration described in FIG. 9, but can be shown with a manual mode or version.

The manual version or configuration can be implemented in one or more steps. For example, a user can open the access panel 158 by applying finger pressure to a spring-loaded plunger. The applied pressure can cause the plunger to partially open the access panel 158. Additionally, the magnetic catches can retain the access panel 158 in a closed position until the plunger is actuated and can allow easy opening without the need for a key, for instance. A user can push the locking pin 116 into a locked position separately for the upper and lower portions of the segment 104 to secure the frame assembly 102. To unlock the frame assembly 102, a user can push the manual release 130 for the upper and lower portions of the segment 104, which includes the locks 112. The manual release 130 can be configured to retract both the upper and lower locking pins 116 simultaneously, thereby unlocking both the top and bottom locks 112 at once.

The structural configuration of the manual version can be similar to the electronic version in terms of the frame assembly 102 and the interchangeable member 146. The member 146 can be mechanically secured within the grooves or central channels 114 of one or more segments 104 of the frame assembly 102 and can be positioned inside the window frame 132. In the manual version, each locking pin 116 can be supported or guided by fixed supports positioned at the upper and lower portions of the segment 104. The electronic version may utilize a rail or the slide rail 118 in conjunction with the actuator 120 for positioning or guiding each locking pin 116. Additional components shown in FIG. 10 can include one or more hinge supports 162 for the access panel 158 to facilitate pivotal mounting and opening of the access panel 158. The components can further include a lock mounting pad 164 for each lock 112. The lock mounting pad 164 can be configured to provide structural support and positioning for each lock 112 within the housing 110.

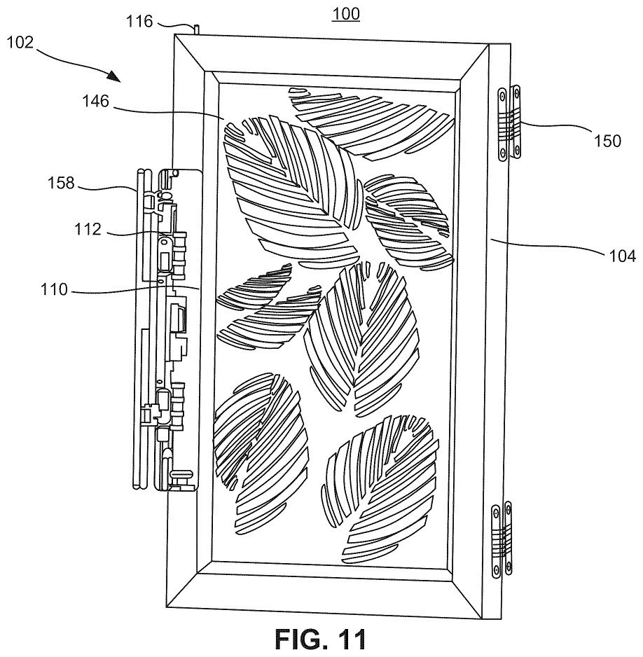

Referring now to FIG. 11, another front view of an example window security system 100 is shown, according to an implementation. As illustrated by way of example in FIG. 11, the electronic mode or version of the window security system 100 is depicted. The front view illustrates the frame assembly 102 in an assembled configuration. As shown, the member 146 can be positioned within the segments 104 of the frame assembly 102, and the access panel 158 can provide access to the housing 110 that includes the one or more locks 112. The electronic version can further include the locking pin 116 (or bolt 116) and hinge slots 150 formed in the surrounding structure for pivotal mounting.

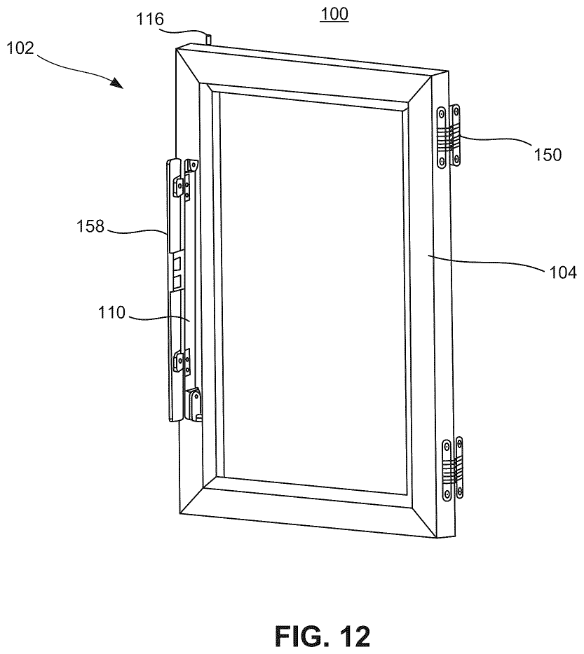

Referring now to FIG. 12, another front view of an example window security system 100 is shown, according to an implementation. As illustrated by way of example in FIG. 12, the mechanical mode or version of the window security system 100 is depicted. The front view illustrates the frame assembly 102 in an assembled configuration. The mechanical version can include the one or more locking pins 116 positioned along the locking side of the frame assembly 102. The access panel 158 can provide entry into the housing 110. The hinge slot 150 can be associated with each corner connector 108 for pivotal mounting of the frame assembly 102 within the window frame 132.

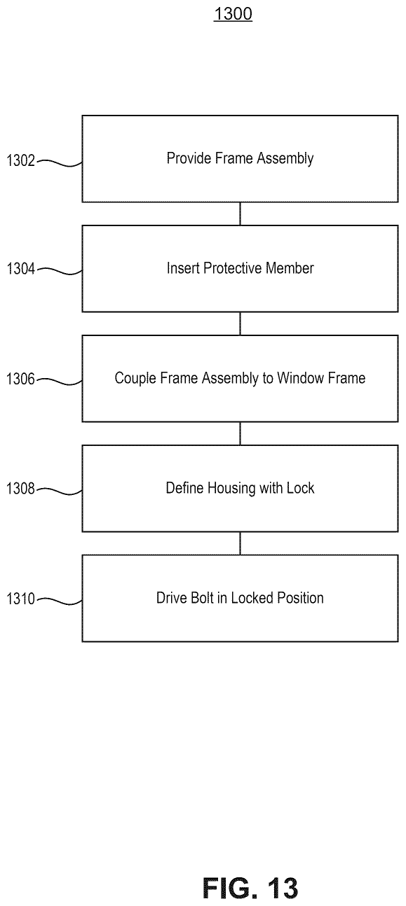

FIG. 13 depicts a method 1300 of securing a window. The method 1300 can be implemented using a window security system 100 or any other features discussed in FIG. 1-12. The method can include Acts 1302-1310. The Acts 1302-1310 can be executed in any order or sequence.

At 1302, the method can include providing a frame assembly. The frame assembly can include a plurality of segments. The plurality of segments can be interconnected by mitered joints. Each segment of the plurality of segments can have a first end and a second end and a central channel extending longitudinally between the first end and the second end. The frame assembly can include a first segment and a second segment that can be parallel to each other. The frame assembly can include a fourth segment coupled to the first segment and the second segment. The frame assembly can include a third segment extending perpendicularly from the first end of a second segment of the frame assembly, where the second segment can be coupled to the window frame. The third segment can include at least one hole positioned at a distance from an edge of the third segment, where the edge of the third segment can be coupled to the first segment of the frame assembly. The at least one hole in the third segment can align with a corresponding hole in the first segment to define a common axis for receiving the bolt.

At 1304, the method can include inserting a protective member. The method can include receiving, within the central channel of at least one segment, a member for protecting the window. The member can include at least one of a bar, a decorative panel, a solid panel, or a reinforcing plate. The central channel of the at least one segment can be configured to receive the member in a movable engagement.

At 1306, the method can include coupling the frame assembly to the window frame. The method can include hingedly coupling, using a connector, the frame assembly to the window frame of the window.

At 1308, the method can include defining a housing with a lock. The method can include defining the housing within a segment of the frame assembly. For example, the housing can be defined within a first segment of the frame assembly. The first segment can be positioned opposite a second segment of the frame assembly, where the second segment can be coupled to the window frame. The housing can include a lock. The lock can include an actuator coupled to a bolt. The lock can be an electro-mechanical lock, including the actuator coupled to the bolt. The bolt can be slidably engaged with a rail configured to guide movement of the bolt. The housing can further include a manual release configured to disengage the lock. The manual release can include at least a key-operated control, a lever-operated control, or a spring-loaded plunger. The housing can further include an access panel for operating the manual release.

The housing can further include a transceiver configured for wireless communication with one or more external devices. The housing can further include a controller operatively coupled to the transceiver. The controller can be configured to activate the lock in response to receiving a control signal from the transceiver. The controller can be further configured to deactivate the lock in response to receiving a deactivation signal from the transceiver.

The housing can further include a sensor configured to detect a security event. The controller can be operatively coupled to the sensor. The controller can be configured to trigger an alert notification to a mobile application installed on one or more external devices in response to receiving a signal from the sensor indicating the security event. The security event can correspond to a deviation from a predetermined operating condition. The method can include providing a power source to power the housing.

At 1310, the method can include driving a bolt in a locked position. The method can include driving, using the actuator, in the locked position, the bolt of the lock into a recess defined in the window frame for positioning the member for protecting the window. The method can include retracting, in an unlocked position, the bolt from the recess defined in the window frame. The method can include providing a sleeve configured to surround the bolt during extension and retraction within the window frame. The method can include pivoting, in the unlocked position, a segment of the frame assembly outward relative to the window frame.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements are merely used to describe the orientation of various elements in the FIGURES. It should be noted that the orientation of various elements may differ according to other exemplary embodiments, and that such variations are intended to be encompassed by the present disclosure.

What is claimed is:

1. A window security system comprising:
a frame assembly comprising a plurality of segments, each segment of the plurality of segments having a first end and a second end and a central channel extending longitudinally between the first end and the second end, wherein the central channel of at least one segment is configured to receive a member for protecting a window;
a connector hingedly coupling the frame assembly to a window frame of the window; and
a housing defined within a segment of the frame assembly, the housing comprising a lock including an actuator coupled to a bolt, the lock configured to couple the frame assembly to the window frame in a locked position, wherein, in the locked position, the actuator drives the bolt into a recess defined in the window frame to position the member for protecting the window.

2. The window security system of claim 1, wherein the member comprises at least one of a bar, a decorative panel, a solid panel, or a reinforcing plate.

3. The window security system of claim 2, wherein the central channel of the at least one segment is configured to receive the member in a movable engagement.

4. The window security system of claim 1, wherein the housing is defined within a first segment of the frame assembly, the first segment positioned opposite a second segment of the frame assembly, wherein the second segment is coupled to the window frame.

5. The window security system of claim 1, wherein the frame assembly comprises a fourth segment coupled to a first segment and a second segment of the frame assembly, wherein the first and second segments are parallel to each other.

6. The window security system of claim 1, wherein the frame assembly comprises a third segment extending perpendicularly from the first end of a second segment of the frame assembly, the second segment being coupled to the window frame.

7. The window security system of claim 6, wherein the third segment includes at least one hole positioned at a distance from an edge of the third segment, wherein the edge of the third segment is coupled to a first segment of the frame assembly, wherein the at least one hole in the third segment aligns with a corresponding hole in the first segment to define a common axis for receiving the bolt.

8. The window security system of claim 1, wherein the lock is an electro-mechanical lock comprising the actuator coupled to the bolt, the bolt being slidably engaged with a rail configured to guide movement of the bolt.

9. The window security system of claim 1, wherein, in an unlocked position, the bolt retracts from the recess defined in the window frame.

10. The window security system of claim 9, wherein, in the unlocked position, a segment of the frame assembly coupled to the window frame is configured to pivot outward relative to the window frame.

11. The window security system of claim 10, further comprising a sleeve configured to surround the bolt during extension and retraction within the window frame.

12. The window security system of claim 1, wherein the housing further comprises a manual release configured to disengage the lock, the manual release comprising at least a key-operated control, a lever-operated control, or a spring-loaded plunger.

13. The window security system of claim 12, wherein the housing further comprises an access panel for operating the manual release.

14. The window security system of claim 1, wherein the housing further comprises:
a transceiver configured for wireless communication with one or more external devices; and
a controller operatively coupled to the transceiver, the controller configured to activate the lock in response to receiving a control signal from the transceiver.

15. The window security system of claim 14, wherein the controller is further configured to deactivate the lock in response to receiving a deactivation signal from the transceiver.

16. The window security system of claim 14, wherein the housing further comprises:
a sensor configured to detect a security event; and
the controller operatively coupled to the sensor, the controller configured to trigger an alert notification to a mobile application installed on one or more external devices in response to receiving a signal from the sensor indicating the security event.

17. The window security system of claim 16, wherein the security event corresponds to a deviation from a predetermined operating condition.

18. The window security system of claim 1, further comprising a power source to power the housing.

19. The window security system of claim 1, wherein the plurality of segments are interconnected by mitered joints.

20. A method of securing a window, the method comprising:
providing a frame assembly having a plurality of segments, each segment having a first end and a second end and a central channel extending longitudinally between the first end and the second end;
receiving, within the central channel of at least one segment, a member for protecting the window;
hingedly coupling, using a connector, the frame assembly to a window frame of the window;
defining, within a segment of the frame assembly, a housing comprising a lock including an actuator coupled to a bolt; and
driving, using the actuator, in a locked position, the bolt of the lock into a recess defined in the window frame for positioning the member for protecting the window.
